(19) United States
(12) Patent Application Publication
(10) Pub. No.: US 2007/0031628 A1
(43) Pub. Date: Feb. 8, 2007

(54) Material for being torn longitudinally along parallel indentations

(76) Inventor: Joseph W. Coburn JR., Jackson, NJ (US)

Correspondence Address: R. GALE RHODES, ESQ. / MOSER IP LAW GROUP, 1040 BROAD STREET, 2ND FLOOR, SHREWSBURY, NJ, 07702, US

(21) Appl. No.: 11/197,225

(22) Filed: Aug. 4, 2005

(51) Int. Cl. G09F 3/00

(52) U.S. Cl. 428/43; 428/156

(57) ABSTRACT

Material for being torn longitudinally along parallel indentations including a layer of longitudinally extending material having opposed surfaces at least one of said surfaces being provided with a plurality of longitudinally extending parallel indentations.

### BACKGROUND OF THE INVENTION

There are numerous practical and decorative applications for longitudinally extending strips or lengths of film or material provided with a relatively uniform width. For example, such longitudinally extending strips or lengths of film or material are used in or as party goods. Material referred to as slit drapes are known wherein one edge portion of a length of material is formed into adjacent and separate lengths of material of relatively uniform width, these slit drapes are sometimes used as a decorative border. To form a layer of material into such longitudinally extending strips or lengths of material of relatively uniform width, and slit drapes, requires that a layer of material be cut with at least some precision, such as by a pair of scissors or the like. It is ofttimes desirable for a person to be able to form the above-noted longitudinally extending strips or lengths of material of relatively uniform width, and slit drapes, on the spot, manually, such as by the fingers of a person, and without the aid of any scissors or other cutting instrument.

Accordingly there is a need in the art for film or material which can be torn longitudinally manually, such as by tearing force applied by the fingers of a person's hands, to produce longitudinally extending strips or lengths of material of relatively uniform width.

### SUMMARY OF THE INVENTION

Material for being torn longitudinally including a layer of longitudinally extending material having opposed surfaces at least one of which is provided with a plurality of longitudinally extending parallel indentations.

### DESCRIPTION OF THE DRAWINGS

FIG. 1 is a diagrammatical illustration of the forming of the first embodiment of the invention;

FIG. 2 is a diagrammatical cross-sectional view taken generally along the line 2-2 in FIG. 1 and in the direction of the arrows and provides an end view of the first invention embodiment;

FIG. 3 is a diagrammatical illustration of the tearing of the first embodiment of the invention in a straight line;

FIG. 4 is a top view of a further embodiment of the invention wherein the ends are provided with V-shaped notches;

FIG. 5 is a diagrammatical illustration of the tearing of the embodiment of FIG. 4 in a straight line;

FIG. 6 is a diagrammatical illustration of one form of packaging of the invention embodiment of FIG. 2 and the providing the ends of such material with V-shaped notches to provide the invention embodiment of FIG. 4;

FIG. 7 is an end view similar to FIG. 2 bit is an end view of a further embodiment of the invention;

FIG. 8 is a diagrammatical illustration of the forming of a still further embodiment of the invention;

FIG. 9 is a diagrammatical cross sectional view taken generally along the line 9-9 in FIG. 8 and in the direction of the arrows; and

FIG. 10 is a diagrammatical illustration showing that the embodiments of the invention may have their upper surface provided with a plurality of longitudinally extending non-straight, e.g. wavy, parallel indentions.

### DETAILED DESCRIPTION OF THE INVENTION

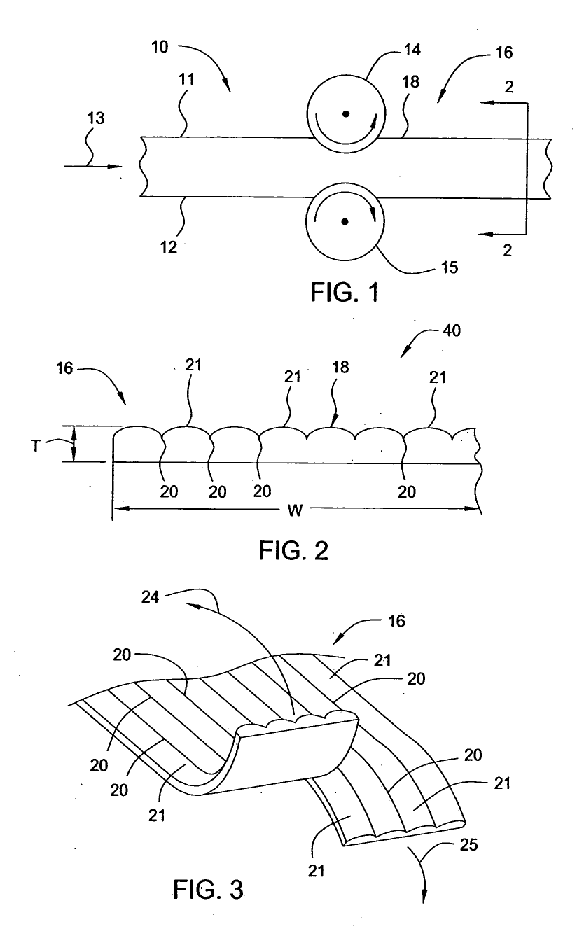

Referring to FIG. 1 and the forming the first embodiment of the invention, a film or layer of deformable and tearable material indicated by general numerical designation 10, having opposed top surface 11 and bottom surface 12, is advanced, in the direction of the arrow 13, between an embossing roller 14 and a back up roller 15 to provide a layer of longitudinally extending material indicated general designation 16 and having its upper portion or surface 18 provided with a plurality of longitudinally straight parallel indentations 20 as shown in FIG. 2 The embossing roller 14 of FIG. 1 may be shaped to provide dome-like portions 21 between adjacent indentations 20 as shown in FIG. 2. In the preferred embodiment the layer of material 16 had a thickness of about 3 mils.

The layer of film or material 10, FIG. 1, may be a suitable film or layer of polymeric material such as polycarbonate, polyvinylchloride (PVC) and polycarbonate compound comprising about 90-92% polycarbonate resin and about 8-10% bromine which is a nonflammable polycarbonate compound. Such polymeric materials may be substantially transparent, or substantially transparent colored, polymeric materials

The material may be cut into sheets or desired lengths by suitable cutting apparatus known to the art. In the preferred embodiment the layer of polymeric material had thickness of about 3 mils.

The material 16, as shown in FIG. 2, has a width W and the material 16 may be provided with from about 50 to about 100 indentations 20 per inch of width; preferably about 75 indentations 20 per inch of width.

As is further shown in FIG. 2 the layer of material 16 has a thickness T and the indentations 20 may extend inwardly into the material 16 from about 25% to about 75% of the thickness, preferably to about 50% of the thickness.

Upon tearing force, indicated by the arrows 24 and 25 in FIG. 3, being applied manually to the film or material 16, such as by the hands of a person, the material 16 tears in a straight line along one of the he longitudinally extending straight indentations 20 and into a longitudinally extending strip or length of material of relatively uniform width as shown in FIG. 3.

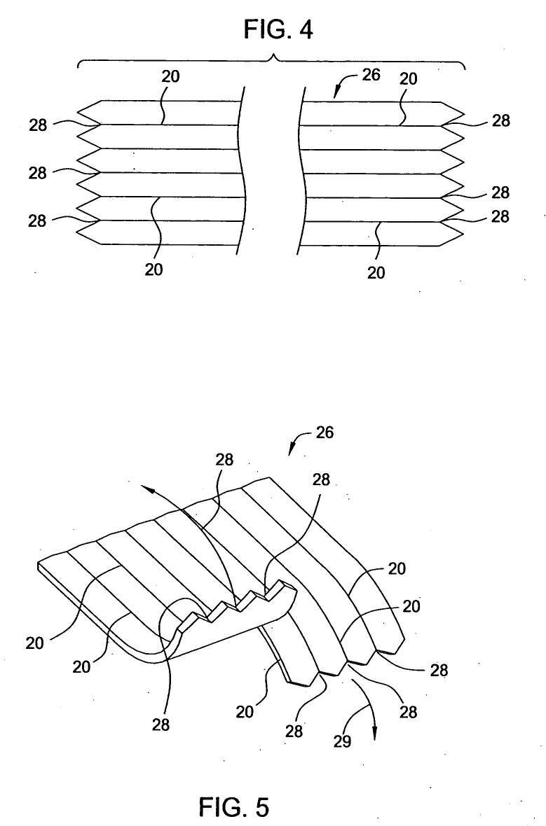

A further embodiment of material for being in a straight line of the present invention is shown in FIG. 4 and indicated by general numerical designation 26. Material 26 is the same as material 16 except that the ends of the material 26 are provided with a transverse row of inwardly extending V-shaped notches 28 disposed perpendicular to the material 26. The row of V-shaped notches may be provided by suitably shaped cutting apparatus known to the art. It will be understood that only one or both of the ends of the material 26 may be provided with the V-shaped notches 28.

At least one of the indentations 20 is coincident with each of the V-shaped notches 28. As illustrated diagrammatically in FIG. 5, upon tearing force, indicated by the arrows 28 and 29, being applied manually to the end of the material 26 at any one of the notches 28, such as by the fingers of a person; the material 26 tears in a straight line along the indentation 20 coincident with the notch at which the tearing force is applied and a strip or length of material of relatively uniform material is provided It will be understood that the V-shaped notches 28 enhance the longitudinally tearing of the material in a straight line.

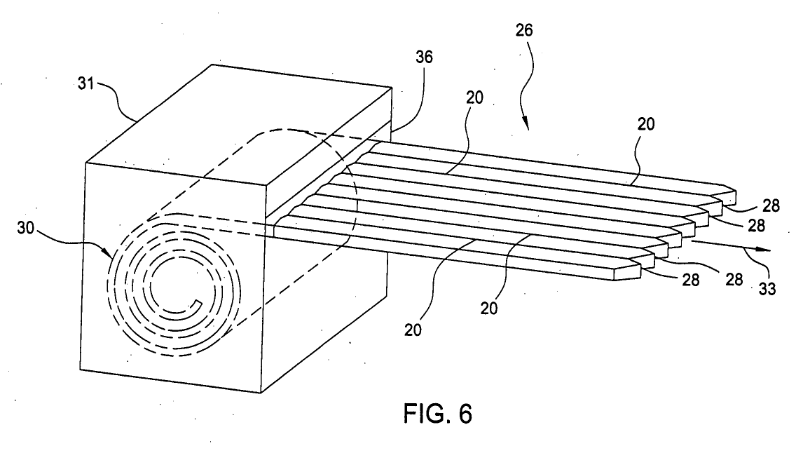

As shown in FIG. 6 the material 16 of FIG. 2 may be rolled into the roll 30 shown in dashed outline and packaged in the box or container 31. The material 16 may be pulled manually out of the box 31, as indicated by the arrow 33 through an opening(not shown) provided in the box 31 and pulled upwardly against the metal cutting member 36, provided with the row of V-shaped cutting notches as shown in FIG. 6, to provide the transverse row of inwardly extending V shaped notches in the end of the material thereby providing the material 26 shown in FIG. 4 and described above.

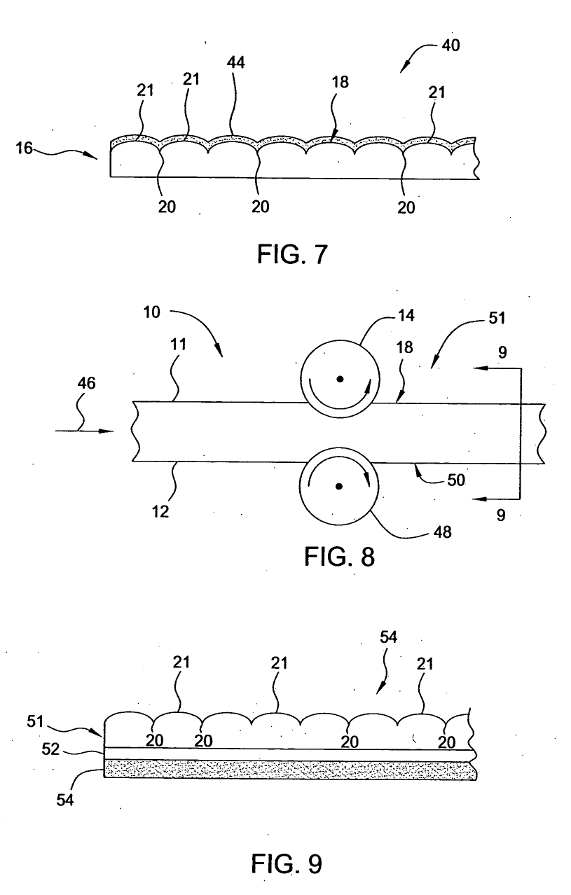

A still further embodiment of the present invention is shown in FIG. 7 and indicated by general designation 40. Material 40 includes the material 16 shown in FIG. 2 and described above and a layer of metallization 44 applied to and covering the surface 18 of the material 16. The layer of metallization 44 may be applied by suitable sputtering or metal vapor deposition. The material 16 may be comprised of any of the polymeric materials described above and may have a thickness of about 3 mils and the layer of metallization 44 may have a thickness of about 50 angstroms. Metallized material 40 may be torn in a straight line the same as material 16 of FIG. 3. Alternatively the material 40 may have one or both of its ends provided with the V-shaped notches 28 to enhance longitudinal tearing in a straight line.

The forming of a still further embodiment of invention is illustrated diagrammatically in FIG. 8.

The layer of material 10, which may be any one of the polymeric materials described above, is advanced, as indicated by the arrow 46, between the embossing or upper roller 14, shown in FIG. 1 and described above, and an opposed or lower embossing roller 48. The upper embossing roller 14 provides the upper surface 18 of the material with the plurality of longitudinally extending straight parallel indentations 20 with adjacent indentations being separated by dome like portions 21 as shown in FIG. 1 and described above. The lower embossing roller 48 provides the lower surface of the material with a decorative pattern such as a hologram, a suitable geometric pattern, a suitable textured pattern, or the like; such decorative patterns are indicated diagrammatically in FIG. 9 by the layer 52. The opposed embossing rollers 14 and 48 cooperate to provide the layer of material indicated by general numerical designation 51 in FIG. 8 and which layer of material 51 in the preferred embodiment had a thickness of about 3 mils and which layer of metallization may have a thickness of about 50 angstroms.

The layer or decorative pattern 52 is covered by a layer of metallization 54(FIG. 9) which may be applied by sputtering or metal vapor deposition. The layer of polymeric material 16 may have a thickness of about 3 mils and the layer of metallization may have a thickness of about 50 angstroms. The material 54 is for being torn in a straight line longitudinally along one of the indentations 20 as shown for the material 16 in FIG. 3, and the material 54 may have one or both of its ends provided with the V shaped notches 28, FIGS. 4 and 5, to enhance longitudinal tearing in a straight line.

The embodiments or materials 26, 40 and 54 may be provided with the same number of longitudinally extending indentations 20 per inch of width as set firth above for the embodiment 16 of FIG. 2, and the indentations 20 may extend into the material of these embodiments the same percentages as set forth above for the material of embodiment 16 as described in connection with FIG. 2.

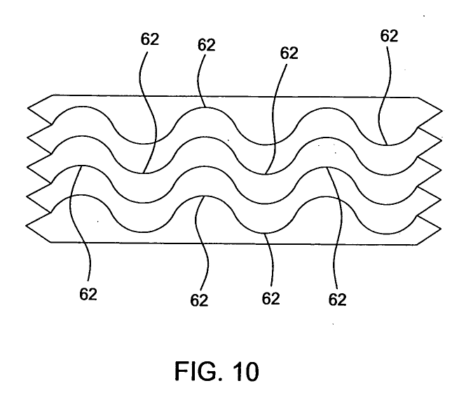

Referring to FIG. 10, it will be understood that the above-described embodiments of the present invention, and shown variously in FIGS. 1-9, may have their upper surface embossed with a plurality of longitudinally extending non-straight parallel indentations such as, for example, the plurality of longitudinally extending wavy, parallel indentations 62 shown in FIG. 10. To form such wavy or non-straight parallel indentations, it will be understood that the embossing roller 14 of FIGS. 1 and 8 will have its embossing surface suitably shaped or configured to provide such plurality of longitudinally extending non-straight, e.g., wavy, parallel indentations. Upon being torn such modified embodiments will provide longitudinally extending non-straight, e.g., wavy, strips or lengths of material of relatively uniform width.

It will be understood that many variations and modifications may be made to the present without departing from the spirit and scope thereof.

What is claimed is:

1. Material for being torn along parallel indentations, comprising:
a layer of longitudinally extending material having opposed surfaces at least one of said surfaces being provided with a plurality of longitudinally extending parallel indentations.

2. The material according to claim 1 wherein said layer of material has at least one end provided with a transverse row of inwardly extending V-shaped notches disposed perpendicular to said layer of material, at least one of said indentations being coincident with each of said V-shaped notches and upon tearing force being applied to said layer of material at any one of said notches said layer of material tearing longitudinally in a straight line along the indentation coincident with said one notch.

3. The material according to claim 1 wherein said layer of material has a width and wherein from about 50 to about 100 of said indentations are provided per inch of width.

4. The material according to claim 3 wherein about 75 of said indentations are provided per inch of width.

5. The material according to claim 1 wherein said layer of material has a thickness and wherein said indentations extend inwardly into said layer of material from about 25% to about 75% of said thickness.

6. The material according to claim 5 wherein said indentations extend inwardly into said layer of material to about 50% of said thickness.

7. The material according to claim 1 wherein said layer of material comprises a layer of polymeric material and a layer of metallization covering said at least one surface.

8. The material according to claim 7 wherein said layer of polymeric material is a layer of polycarbonate.

9. The material according to claim 7 wherein said layer of polymeric material is a layer of a polycarbonate compound comprising about 90-92% polycarbonate resin and about 8-10% bromine.

10. The material according to claim 7 wherein said layer of polymeric material has a thickness of about 3 mils and wherein said layer of metallization has a thickness of about 50 angstroms.

11. The material according to claim 2 wherein adjacent indentations are separated by a dome-like portion of said material.

12. The material according to claim 1 wherein said layer of material is a layer of colored material.

13. The material according to claim 12 wherein said layer of colored material is a layer of substantially transparent colored polymeric material, wherein the other of said surfaces is provided with a decorative pattern and wherein said material further comprises a layer of metallization covering said decorative pattern.

14. The material according to claim 13 wherein said layer of substantially transparent colored polymeric material has at least one end provided with a transverse row of inwardly extending V-shaped notches disposed perpendicular to said layer of substantially transparent colored polymeric material, at least one of said indentations being coincident with each of said V-shaped notches and upon tearing force being applied to said layer of substantially transparent polymeric material at any one of said notches said layer of substantially transparent colored polymeric material tearing longitudinally in a straight line along the indentation coincident with said one notch.

15. The material according to claim 13 wherein said layer of substantially transparent colored polymeric material has a width and wherein from 50 to 100 of said indentations are provided per inch of width.

16. The material according to claim 15 wherein 75 of said indentations are provided per inch of width.

17. The material according to claim 13 wherein said layer of substantially transparent colored polymeric material has a thickness and wherein said indentations extend inwardly into said layer of substantially transparent colored polymeric material from about 25% to about 75% of said thickness.

18. The material according to claim 17 wherein said indentations extend inwardly into said layer of substantially transparent colored polymeric material to about 50% of said thickness.

19. The material according to claim 13 wherein said layer of substantially transparent colored polymeric material is a layer of substantially transparent colored polycarbonate.

20. The material according to claim 13 wherein said layer of substantially transparent colored polymeric material is a layer of substantially transparent colored polycarbonate compound comprising about 90-92% polyccarbonate resin and about 8-10% bromine.

21. The material according to claim 13 wherein said layer of substantially transparent colored polymeric material has a thickness of about 3 mils and wherein said layer of metallization has a thickness of about 50 angstroms.

22. The material according to claim 13 wherein adjacent indentations are separated by a dome-like portion of said substantially transparent colored polymeric material.

23. The material according to claim 1 wherein said layer of longitudinally extending material is a layer of longitudinally extending deformable, and tearable material.

24. The material according to claim 23 wherein said layer of longitudinally extending material is a layer of longitudinally extending deformable, tearable 5nd non-flammable material.

25. The material according to claim 2 wherein said layer of material has a second end opposite said one end, wherein said second end is provided with a second transverse row of inwardly extending V-shaped notches disposed perpendicularly to said layer of material, at least one of said indentations being coincident with each of said V-shaped notches in said second transverse row of inwardly extending V-shaped notches whereby upon a tearing force being applied to either end of said layer of material at any one of said notches said layer of material tearing in a straight line along the indentation coincident said one notch.

26. The material according to claim 1 wherein said plurality of indentations are a plurality of longitudinally extending straight parallel indentations.

27. The material according to claim 1 wherein said indentations are a plurality of longitudinally extending non-straight parallel indentations.

28. The material according to claim 27 wherein said non straight parallel indentations are a plurality of longitudinally extending wavy parallel indentations.
